(19) United States
(12) Patent Application Publication
(10) Pub. No.: US 2014/0152549 A1
(43) Pub. Date: Jun. 5, 2014

(54) SYSTEM AND METHOD FOR PROVIDING USER INTERFACE USING HAND SHAPE TRACE RECOGNITION IN VEHICLE

(71) Applicant: Hyundai Motor Company, Seoul (KR)

(72) Inventor: Sung Un Kim, Yongin (KR)

(73) Assignee: Hyundai Motor Company, Seoul (KR)

(21) Appl. No.: 14/068,409

(22) Filed: Oct. 31, 2013

(30) Foreign Application Priority Data
Dec. 5, 2012 (KR) 10-2012-0140589

(51) Int. Cl. G06F 3/01

(52) U.S. Cl. CPC G06F 3/017
USPC 345/156

(57) ABSTRACT

A system and method of manipulating a user interface using hand shape trace recognition within a vehicle includes receiving, by a controller, an input of a passenger image and recognizing the hand shape trace information from the passenger image. In addition, the controller is configured to select a vehicle device manipulation that corresponds to the recognized hand shape trace. Therefore, when a passenger manipulates a steering wheel with one hand while viewing the front side, various electronic devices within the vehicle are controlled with a motion of one hand.

### CROSS-REFERENCE TO RELATED APPLICATION

This application claims priority to and the benefit of Korean Patent Application No. 10-2012-0140589 filed in the Korean Intellectual Property Office on Dec. 5, 2012, the entire contents of which are incorporated herein by reference.

### BACKGROUND

(a) Field of the Invention

The present invention relates to a system and method of manipulating a user interface that controls devices within a vehicle by recognizing a vehicle passenger's hand shape trace.

(b) Description of the Related Art

For convenience of a passenger, various electronic devices are mounted within recently developed vehicles. Within the vehicle, in addition to an electronic device of an existing radio receiver and air conditioner, electronic devices such as a navigation system and a mobile phone hands free system are being mounted. Existing electronic devices within the vehicle provide a user interface via a designated button, and recently, a touch screen is widely being used as a user interface. Such devices should be directly touched and manipulated by a passenger. Further, since such an operation is usually performed by the passenger's viewing and hand operation, the operation may disturb safe driving. Therefore, when the passenger performs such an operation, a sufficient visual range and position of the user interface should be considered to promote safe driving.

A system that recognizes a passenger's hand image and that controls a vehicle function has been developed, and the system does not require the passenger to divert attention from driving and controls a vehicle function, thus promoting safe driving.

However, when extracting a characteristic point of a hand image, the conventional system is affected by disturbance light and has a hand image change influence by a hand shape, and it may be difficult to obtain a meaningful characteristic point in various conditions since the system is based on a two-dimensional image. Therefore, a characteristic point should be found with only color and brightness information, and determination of a characteristic point is deteriorated due to outside lighting.

The above information disclosed in this section is only for enhancement of understanding of the background of the invention and therefore it may contain information that does not form the prior art that is already known in this country to a person of ordinary skill in the art.

### SUMMARY

The present invention provides a system and method for manipulating a user interface having advantages of controlling various electronic devices within a vehicle by recognizing a passenger's hand shape trace (e.g., the path of a hand motion).

An exemplary embodiment of the present invention provides a method of manipulating a user interface using hand shape trace recognition within a vehicle, the method including: receiving an input of a passenger image; recognizing passenger hand shape trace information from the passenger image; and selecting a vehicle device manipulation that corresponds to the recognized hand shape trace information.

The receiving of an input may include receiving an input of a passenger hand image from an image photographing unit and accumulating and storing the image at an image storage unit; and calculating a difference between a present frame and a previous frame of the photographed image and acquiring the passenger hand shape trace information. The recognizing of the passenger's hand shape trace information may include determining whether hand shape trace information that is matched to the hand shape trace information is stored in an information database; and recognizing, when hand shape trace information that is matched to the hand shape trace information is stored in an information database, the hand shape trace information.

The method may further include determining whether a hand shape trace recognition function use request exists, before the receiving of an input, wherein the receiving of an input of a passenger image may be performed, when a hand shape trace recognition function use request exists.

The method may further include: determining whether a hand shape trace recognition function use termination request exists; and terminating, when a hand shape trace recognition function use termination request exists, use of the hand shape trace recognition function.

Another embodiment of the present invention provides a user interface manipulation system that uses hand shape trace recognition within a vehicle, the user interface manipulation system including: an image photographing unit that captures a passenger image; an image storage unit that stores the captured passenger image; an information database that stores recognizable hand shape trace information; and an electronic control unit that executes a vehicle device manipulation based on an input signal from the image photographing unit and cumulative image information that is stored in the image storage unit, wherein the electronic control unit executes a series of commands for performing a user interface manipulation method.

The user interface manipulation system may further include: an input unit that receives an input of a request signal for use of a hand shape trace recognition function from a passenger to transfer the request signal to the electronic control unit; and an output unit that displays vehicle device manipulation contents of the electronic control unit.

In a method of manipulating a user interface using hand shape trace recognition according to an exemplary embodiment of the present invention, a passenger's hand shape trace may be extracted via an image photographing unit and it may be determined whether hand shape trace information is matched to a hand shape trace that is stored in an information database, and by recognizing the matched hand shape trace information, a manipulation of a corresponding vehicle device may be selected.

Therefore, even when an influence of external lighting exists, since trace information may be recognized more accurately, while a passenger manipulates a steering wheel with one hand and views the front side, various electronic devices within the vehicle may be controlled with a simple motion of another hand and thus the passenger's convenience and driving safety may be improved.

### BRIEF DESCRIPTION OF THE DRAWINGS

FIG. 1 is an exemplary diagram illustrating a user interface system using hand shape trace recognition within a vehicle according to an exemplary embodiment of the present invention;

FIG. 2 is an exemplary flowchart illustrating a method of manipulating a user interface using hand shape trace recognition within a vehicle according to an exemplary embodiment of the present invention;

FIG. 3 is an exemplary diagram illustrating operation corresponding to hand shape trace according to an exemplary embodiment of the present invention; and

FIG. 4 is an exemplary diagram illustrating hand shape trace generation according to an exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

The present invention will be described more fully hereinafter with reference to the accompanying drawing. As those skilled in the art would realize, the described exemplary embodiments may be modified in various different ways, all without departing from the spirit or scope of the present invention. Further, in the drawings, a size and thickness of each element are randomly represented for better understanding and ease of description, and the present invention is not limited thereto.

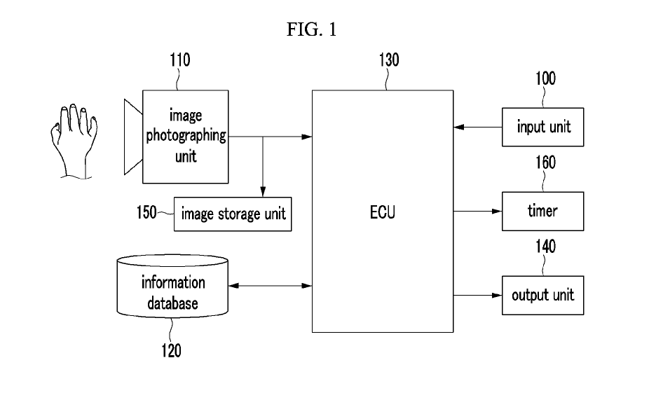

FIG. 1 is an exemplary diagram illustrating a user interface device using hand shape trace recognition according to an exemplary embodiment of the present invention.

Referring to FIG. 1, a user interface (UI) device using a hand shape trace may include a plurality of units executed by an electronic control unit (ECU, controller) 130. The plurality of units may include an input unit 100, an image storage unit 150, a timer 160, an image photographing unit 110 (e.g., an imaging device), an information database 120, and an output unit 140.

The input unit 100 may include a button and a touch screen. In particular, an input may generate an input signal through a button or a touch screen, but as another input method, a voice or a gesture may be used. The image photographing unit 110 may include a camera, a photo sensor, an ultrasonic wave sensor, and an image sensor, and for accurate hand shape recognition, the image sensor is most advantageous. A position of the image photographing unit 110 may be below or above a steering wheel. Furthermore, the image storage unit 150 may be configured to accumulate and store frames of an image captured by the image photographing unit 110. The timer 160 may be configured to determine a time.

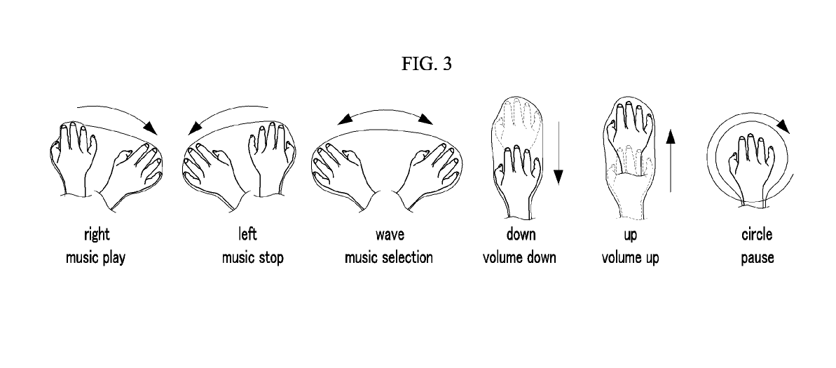

In addition, the information database 120 may be configured to store previously defined hand shape trace information. The stored hand shape trace information may be preset for a generally defined trace. For example, preset hand shape trace information may be a form as shown in FIG. 3 and may have other various hand shape traces. In FIG. 3, a hand motion of a motion to the right, a motion to the left, waving, a motion downward, a motion upward, and a motion of a circle form are defined as music play, music stop, music selection, volume up, volume down and pause, but such a definition may be variously changed.

Further, the information database 120 may be configured to store hand shape trace information registered by the passenger. The passenger may select and store various hand shape trace information. In other words, to enable recognition of different hand shape trace information of each passenger with minimal error, each passenger may directly input the passenger's hand shape trace.

The ECU 130 may be configured to compare a present frame of the captured passenger's hand image and a cumulative image frame that is stored in the image storage unit 150 and may be configured to acquire hand shape trace information that is formed for a predetermined time. The predetermined time may be a time period in which a hand shape trace is formed and may be set by the timer 160.

An image processing may be performed based on a human body image, as needed. That is, a human body peripheral image may be removed from the passenger's human body image, and an extracted image may be classified into a head, a middle section, each arm, each hand, and each leg and may be formed in a model. By tracking the modeled hand image, hand shape trace information may be acquired.

Further, the ECU 130 may be configured to determine whether hand image trace information that is matched to the acquired hand image trace information is stored at the information database 120. When hand image trace information that is matched to the acquired hand image trace information is stored in the information database 120, the ECU 130 may be configured to recognize the stored hand image trace information as the passenger's hand image trace. When hand image trace information that is matched to the acquired hand image trace information is not stored at the information database 120, the passenger's hand image trace information may not be recognized as unidentifiable information.

Additionally, the ECU 130 may be configured to determine whether to use a hand shape trace recognition function based on an input signal of the input unit 100. In other words, when an input signal that instructs to use or terminate a hand shape trace recognition function is received by the ECU, the ECU 130 may be configured to operate the image photographing unit 110 to start or terminate to capture the passenger image. In particular, the ECU 130 may be configured to operate the image photographing unit 110 to capture an image of a moving area of a user hand.

Furthermore, the ECU 130 may be configured to select a vehicle device manipulation that corresponds to the recognized hand shape trace. A corresponding vehicle device manipulation list may be formed and stored in a database. The ECU 130 may be configured to generate a control signal based on the selected vehicle device manipulation and provide a desired manipulation. For example, a selectable vehicle device manipulation may be reception/turning off of an incoming call of a mobile phone, music play/stop/mute, volume up/down, and sun visor manipulation.

The output unit 140 may include a touch screen, a speaker, and a mobile phone, a music device, an air conditioner, and a sun visor to be the vehicle device manipulation target. Further, the output unit 140 may be configured to output vehicle device manipulation contents on a display (e.g., a screen).

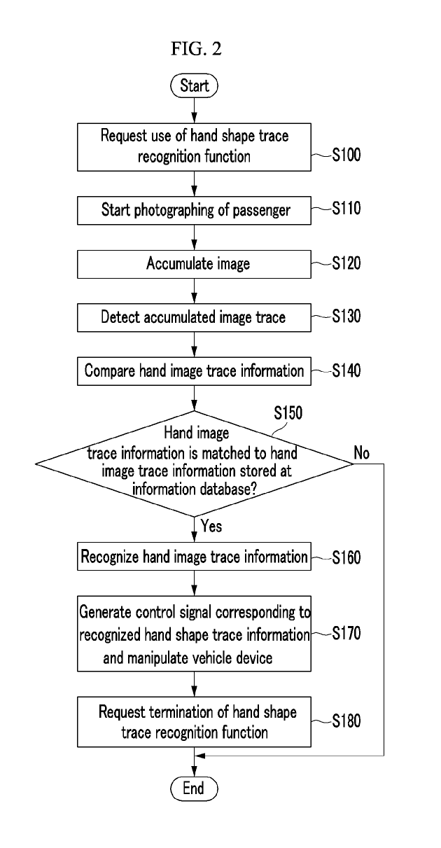

FIG. 2 is an exemplary flowchart illustrating a method of manipulating a user interface using hand shape trace recognition according to an exemplary embodiment of the present invention.

Referring to FIG. 2, a passenger may request a hand shape trace recognition function via the input unit 100 (S 100). When use of a hand shape trace recognition function is requested by the passenger, the ECU 130 may be configured to being capturing passenger hand images (S110). In particular, an image photographing unit 110 (e.g., an imaging device) may be operated by the ECU to photograph the passenger's entire human body.

Thereafter, a captured image may be stored, by the ECU, in the image storage unit 150. Such an image may be accumulated and stored for a predetermined time (S 120). The ECU 130 may be configured to compare a present frame of the passenger's hand image and a cumulative image frame that is stored in the image storage unit 150 and may be configured to acquire hand shape trace information that is formed at a predetermined time (S 130). Specifically, hand shape trace information may be generated by collection of a process of comparing a present image and a previous image. For example, it is similar to a motion of the hand is shown as a shape of trace when misted window is cleaned by a hand.

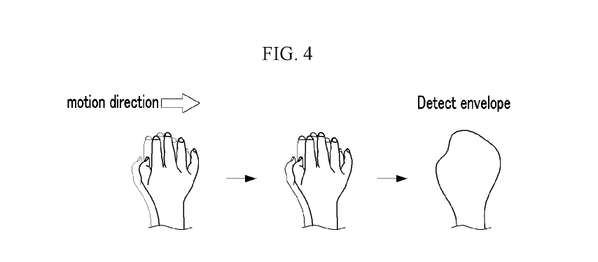

For example, as shown in FIG. 4, when spatially combining pixels in which an image is changed by comparison of a present image and a previous image, an envelope may be detected. By repeating such a process, a hand shape trace may be obtained.

By actually comparing a present image and a previous image, a pixel value of a screen in which a motion occurs may be displayed as 1 and a pixel value of a screen in which a motion does not occur may be displayed as 0, and when tracking a change form of an area 1 in which a motion occurs, a hand shape trace may be acquired. The number of image frames for acquiring such a hand shape trace may be the number that corresponds to a predetermined time and may be previously determined, as needed. Hand shape trace information may be acquired by another method instead of comparison between a present frame and a previous frame, as needed. The predetermined time may be a time period in which a hand shape trace is formed and may be set by the timer 160.

An image processing may be performed based on a human body image, as needed. In other words, a human body peripheral image may be removed from the passenger's human body image, and an extracted image may be classified into a head, a middle section, each arm, each hand, and each leg and may be formed in a model. By tracking the modeled hand image, hand shape trace information may be acquired.

Thereafter, the ECU 130 may be configured to compare the acquired hand image trace information and matched hand image trace information that is stored at the information database 120 (S140). The ECU 130 may be configured to determine whether hand image trace information that is matched to the acquired hand image trace information is stored at the information database 120 (S150), and when hand image trace information that is matched to the acquired hand image trace information is stored at the information database 120, the ECU 130 may be configured to recognize the stored hand image trace information as the passenger's hand image trace (S160). When hand image trace information that is matched to the acquired hand image trace information is not stored at the information database 120, the passenger's hand image trace information may not be recognized as unidentifiable information.

Thereafter, the ECU 130 may be configured to select a vehicle device manipulation that corresponds to the recognized hand shape trace information. The ECU 130 may be configured to generate a control signal based on the selected vehicle device manipulation and provide a requested manipulation (S170). Such a vehicle device manipulation may include a manipulation of a device such as an air conditioning device and an audio system within the vehicle and may be applied to operation of transfer, copy, storage, and correction of information such as contents or media. A manipulation result may be displayed by the ECU via the output unit 140, and a user interface using hand shape trace recognition may be terminated according to a request of hand shape trace recognition function termination of a driver (S180).

In an exemplary embodiment of the present invention, since an accumulated trace may be used, by removing an influence by an external environment factor, a hand shape trace may be obtained.

While this invention has been described in connection with what is presently considered to be exemplary embodiments, it is to be understood that the invention is not limited to the disclosed embodiments. On the contrary, it is intended to cover various modifications and equivalent arrangements included within the spirit and scope of the accompanying claims.

### DESCRIPTION OF SYMBOLS

| | |
|---|---|
| 100: input unit | 110: image photographing unit |
| 120: information database | 130: electronic control unit (ECU) |
| 140: output unit | 150: image storage unit |
| 160: timer | |

What is claimed is:

1. A method of manipulating a user interface using hand shape trace recognition within a vehicle, the method comprising:
receiving, by a controller, an input of a passenger image;
recognizing, by the controller, hand shape trace information from the passenger image; and
selecting, by the controller, a vehicle device manipulation that corresponds to the recognized hand shape trace information.

2. The method of claim 1, wherein the receiving of an input includes:
receiving, by the controller, an input of a passenger hand image from an imaging device and accumulating and storing the passenger hand image; and
calculating, by the controller, a difference between a present frame and a previous frame of the passenger hand image and acquiring the hand shape trace information.

3. The method of claim 2, wherein the recognizing of the hand shape trace information includes:
determining, by the controller, whether hand shape trace information that is matched to the hand shape trace information is stored in an information database; and
recognizing, by the controller, when hand shape trace information that is matched to the hand shape trace information is stored in the information database, the hand shape trace information.

4. The method of claim 1, further comprising:
determining, by the controller, whether a hand shape trace recognition function use request exists, before the receiving of the input,
wherein the receiving of the input of a passenger image is performed, when a hand shape trace recognition function use request exists.

5. The method of claim 4, further comprising:
determining, by the controller, whether a hand shape trace recognition function use termination request exists; and
terminating, by the controller, use of the hand shape trace recognition function when a hand shape trace recognition function use termination request exists.

6. A user interface manipulation system using hand shape trace recognition within a vehicle, the user interface manipulation system comprising:
an imaging device configured to capture a passenger image; and
a controller configured to:
store the passenger image;
store recognizable hand shape trace information in an information database; and
receive an input of the captured passenger image;
recognize hand shape trace information from the captured passenger image; and
select a vehicle device manipulation that corresponds to the recognized hand shape trace information.

7. The user interface manipulation system of claim 6, wherein the controller is further configured to:
receive the input of a passenger hand image from the imaging device and accumulate and store the passenger hand image; and
calculate a difference between a present frame and a previous frame of the passenger hand image and acquire the hand shape trace information.

8. The user interface manipulation system of claim 7, wherein the controller is further configured to:
determine whether hand shape trace information that is matched to the hand shape trace information is stored in the information database; and
recognize when hand shape trace information that is matched to the hand shape trace information is stored in the information database, the hand shape trace information.

9. The user interface manipulation system of claim 6, wherein the controller is further configured to:
determine whether a hand shape trace recognition function use request exists, before the receiving of the input,
wherein the input of a passenger image is received, when a hand shape trace recognition function use request exists.

10. The user interface manipulation system of claim 9, wherein the controller is further configured to:
determine whether a hand shape trace recognition function use termination request exists; and
terminate when a hand shape trace recognition function use termination request exists, use of the hand shape trace recognition function.

11. A non-transitory computer readable medium containing program instructions executed by a controller, the computer readable medium comprising:
program instructions that control an imaging device to capture a passenger image;
program instructions that store the passenger image;
program instructions that store recognizable hand shape trace information in an information database;
program instructions that receive an input of the captured passenger image;
program instructions that recognize hand shape trace information from the captured passenger image; and
program instructions that select a vehicle device manipulation that corresponds to the recognized hand shape trace information.

12. The non-transitory computer readable medium of claim 11, further comprising:
program instructions that receive the input of a passenger hand image from the imaging device and accumulate and store the passenger hand image; and
program instructions that calculate a difference between a present frame and a previous frame of the passenger hand image and acquire the hand shape trace information.

13. The non-transitory computer readable medium of claim 12, further comprising:
program instructions that determine whether hand shape trace information that is matched to the hand shape trace information is stored in the information database; and
program instructions that recognize when hand shape trace information that is matched to the hand shape trace information is stored in the information database, the hand shape trace information.

14. The non-transitory computer readable medium of claim 11, further comprising:
program instructions that determine whether a hand shape trace recognition function use request exists, before the receiving of the input;
program instructions that receive the input of a passenger image when a hand shape trace recognition function use request exists.

15. The non-transitory computer readable medium of claim 14, further comprising:
program instructions that determine whether a hand shape trace recognition function use termination request exists; and
program instructions that terminate when a hand shape trace recognition function use termination request exists, use of the hand shape trace recognition function.
